(19) United States
(12) Patent Application Publication
(10) Pub. No.: US 2002/0194027 A1
(43) Pub. Date: Dec. 19, 2002

(54) EOB distribution system

(76) Inventor: Thomas L. Smith, Bellevue, NE (US)

Correspondence Address: LAW OFFICES OF ADAM H. JACOBS, 1904 FARNAM STREET, SUITE 726, OMAHA, NE, 68102, US

(21) Appl. No.: 10/172,846

(22) Filed: Jun. 17, 2002

Related U.S. Application Data
(60) Provisional application No. 60/299,030, filed on Jun. 18, 2001.

(51) Int. Cl. G06F 17/60

(52) U.S. Cl. 705/2

(57) ABSTRACT

An explanation of benefits file (EOB file) sharing and distribution system includes at least two EOB file generating sources and a central EOB file storage database in information transmission connection with the at least two EOB file generating sources, the central EOB file storage database operative to receive EOB files from the at least two EOB file generating sources, organize the EOB files within the central EOB file storage database and store the EOB files in the central EOB file storage database. At least one medical care provider is in access-controlled information transmission connection with the central EOB file storage database via the remote data transfer system such that the at least one medical care provider can access and review EOB files which are related to the medical care provider and which are stored in the central EOB file storage database.

### CROSS-REFERENCE TO RELATED PROVISIONAL APPLICATION

This application claims priority to the filing date of related provisional patent application serial No. 60/299,030 filed Jun. 18, 2001.

### BACKGROUND OF THE INVENTION

1. Technical Field

The present invention relates to insurance companies/medical care provider data transfer systems and, more particularly, to an explanation of benefits/remittance advice file sharing and distribution system in which explanation of benefits data is received from various insurance companies providing coverage, the data then being sorted and stored in an Internet-accessible server such that medical care providers can access the EOB's stored on the server via the Internet and receive current EOB's from multiple insurance companies without requiring separate reports submitted from each company to the medical care provider via standard delivery methods, thereby acting as a “clearing house” for the EOBs.

2. Description of the Prior Art

An Explanation of Benefits (EOB) is commonly a statement detailing a patient's medical benefits account activity. Whenever an insured patient receives health care services from a doctor, specialist, hospital or other facility, an EOB with complete information about the service provided and charges paid will be sent to the patient and to the medical care provider by the insurance company or the payor, such as Medicare or Medicaid. This document tells the medical care provider what is covered by the patient's insurance and is an excellent record-keeping device used throughout the health care industry.

Presently, each medical care provider receives a separate explanation of benefits summary from each of the insurance companies which provide for health care benefits, of which there are hundreds. Needless to say, the medical care provider receiving volumes of paperwork from numerous insurance companies is hard-pressed to maintain accurate records which are easily accessible on a patient-by-patient basis. The situation is exacerbated by the sheer number of insurance companies currently providing benefits, particularly HMO's and other such healthcare benefit providers. There is therefore a need for an easily accessible, easily updateable central database where a medical care provider can access this vast amount of information and receive a single informative report for his or her patients.

As each healthcare benefit provider sends a separate EOB to the medical care provider, the onus is on the medical care provider to keep track of the amount of insurance benefits received for each patient. With many practices having upwards of five thousand (5,000) patients, this task can become almost unmanageable due to the database volume and amount of information which needs to be received, entered and organized. There are various systems which are found in the prior art for organizing database information, but there are at present no systems for receiving patient insurance information from multiple sources electronically, organizing the information into an easily accessible and updateable database and permitting controlled access to the database by medical care providers for patient insurance information.

Therefore, an object of the present invention is to provide an improved explanation of benefits distribution system.

Another object of the present invention is to provide an improved explanation of benefits distribution system which provides quick and simple access to assorted EOB files for patients by medical providers.

Another object of the present invention is to provide an improved explanation of benefits distribution system which receives EOB data from a plurality of insurance providers, identifies and sorts the received EOB data in an accessible database and updates the received EOB data and tracks access to the database for use by medical care providers.

Another object of the present invention is to provide an improved explanation of benefits distribution system which centralizes EOB data so that insurers and medical providers can quickly and easily exchange information on patient's coverage and payment information.

Finally, an object of the present invention is to provide an improved explanation of benefits distribution system which is relatively simple to install and service and is safe, efficient and confidential in use.

### SUMMARY OF THE INVENTION

The present invention provides an explanation of benefits file (EOB file) sharing and distribution system including at least two EOB file generating sources and a central EOB file storage database in electronic information transmission connection with the at least two EOB file generating sources, the central EOB file storage database operative to receive EOB files from the at least two EOB file generating sources, organize the EOB files within the central EOB file storage database and store the EOB files in the central EOB file storage database such that the EOB files are accessible via a remote data transfer system selected from the group consisting of a LAN, a WAN, the Internet and the World Wide Web. At least one medical care provider is in access-controlled electronic information transmission connection with the central EOB file storage database via the remote data transfer system such that the at least one medical care provider can access EOB files stored in the central EOB file storage database, and the at least two EOB file generating sources, the central EOB file storage database and the at least one medical care provider cooperate to transfer information via the EOB files such that insurance information regarding patients is accessible by the at least one medical care provider free of requiring separate reports to be submitted from the at least two EOB file generating sources to the at least one medical care provider.

The present invention provides an efficient, rapid and confidential system by which EOB files are transferred and viewed by medical care providers. As each insurance carrier submits their EOB files to the central database, the information is organized and cross-referenced according to several different methods, including by name, doctor, insurer, etc. The present invention thus allows a medical care provider to quickly access their client's insurance information regardless of the insurance carrier or the status of the claim, as such information will be constantly updated to ensure accuracy. Furthermore, security measures will restrict access to the database allowing users to access only those EOB files which are related to their practice, so that patient records will remain confidential and private. Finally, the present invention can allow more accurate documentation of medical history than is currently provided by the prior art, as the centralization of the patient's insurance records will be immediately accessible given permission by the patient. The present invention thus provides a substantial improvement over those database organization systems found in the prior art.

### BRIEF DESCRIPTION OF THE DRAWINGS

FIG. 1 is a high-level flow diagram of the EOB system of the present invention.

### DESCRIPTION OF THE PREFERRED EMBODIMENT

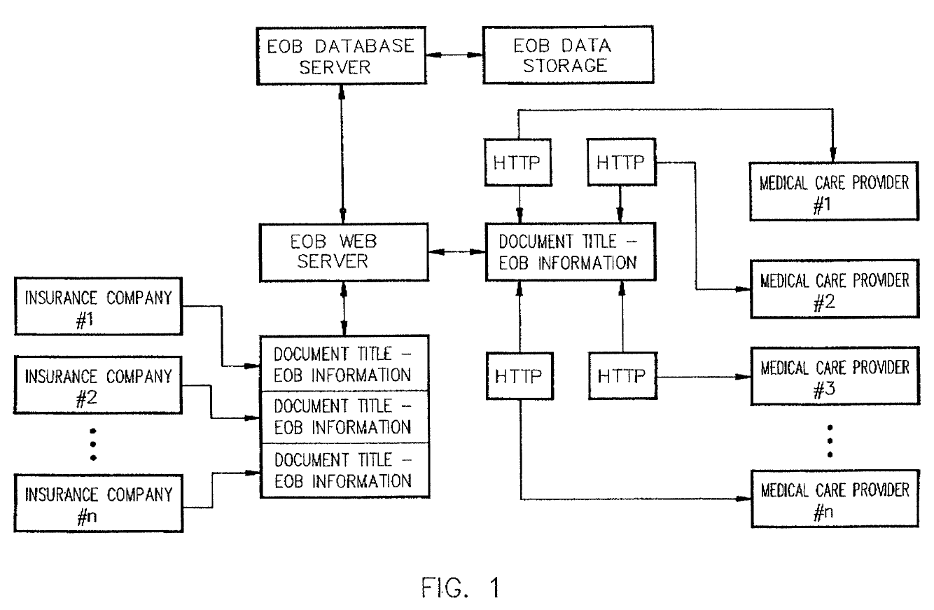

The explanation of benefits (EOB) system of the present invention is shown best in FIG. 1 as providing an interface between EOB file generating sources such as insurance company benefit providers and medical care providers via an Internet-based data exchange system or other such remote data transfer system such as a LAN, a WAN, or the World Wide Web. As shown in FIG. 1, a plurality of insurance companies forward their EOB data to a central database which is maintained by an independent organization. The EOB data would include the standard patient information ordinarily found in EOBs but would be rendered in electronic form in order to transfer the data to the centralized database. In the preferred embodiment the transfer of data would be via the Internet, although it is to be understood that various other types of point to point data transfer systems such as a dedicated T1 line or other such data transfer link could be substituted for the Internet. As each of the EOBs are received by the centralized database, they are stored in the database in an easily cross-referenced manner. This permits the FOB data to be sorted according to various elements of the data, such as healthcare provider name, patient name, insurance provider name and other such database elements. It is expected that the EOB database and server will be of the standard type currently used for storage of large quantities of electronic information, any of which would be understood by one skilled in the art of database management and any of which would be acceptable for use with the present invention. Furthermore, it should be noted that although the present invention is described for use in connection with EOB files of the standard format (i.e. according to the HIPAA (Health Insurance Portability and Accountability Act) of 1996, EOB files must be in certain formats, namely Module 835 format), the present invention is designed to function with other such patient information formats which are used in the medical industry.

The second critical element of the present invention is the accessibility of the EOB database by medical care providers which is necessary for the proper functioning of the present invention. It is expected that proprietary software will map the pertinent information from each of the EOBs stored within the database onto specific pages so that a medical care provider may log onto the secured web site which provides access to the database and access all of the EOBs for that provider. A critical element of the software will be to prevent unauthorized access by other medical care providers to EOBs not directly related to that specific medical care provider, and the proprietary software used in the present invention will prevent such occurrences. It is to be understood that the proprietary software will include security features which are understood by those skilled in the art of programming software security features.

Once the medical care provider accesses the EOB database by submitting a unique identifier such as a password or identification number, he or she is permitted access to any and all stored EOBs that are specifically connected to that provider and which are present on the database. The provider may then print out a copy of those EOBs or merely access the EOBs for informational purposes, but the important feature is that those EOBs which have been accessed continue to be stored on the database for an indefinite period of time so that the provider may reference those EOBs at a later date, thus enabling the provider to greatly reduce his or her storage space allotted to storage of the EOBs.

Finally, at the time that the EOB is transmitted electronically to the central database, the insurance company will directly deposit electronically any payments to the providers bank account thus reducing the amount of time expended in pursuit of those funds. As can be seen, this represents a great savings in time, printing expense and manpower dedicated to maintenance of the EOB records, thus resulting in savings for both the insurance companies and the medical care provider.

One example of the operative embodiment of the present invention is described herein as including the following steps: The insurance companies will push their EOB data to the EOB System Web Server. The EOB system will authenticate via a unique id/password the identity of the insurance company before allowing any EOB data to be pushed to the EOB System Web Server. The EOB system developers will provide a standard EOB interface such as an Extensible Markup Language (XML) interface definition that the insurance company can use to tag the fields in their EOB data. If the insurance company does not want to format their EOB data into this pre-defined format, then a translation listener routine will be created on the Web Server to translate the insurance company's data from their proprietary format to the pre-defined EOB data format. Each translation listener shall reside at a unique public address on the Web Server.

The EOB System will then extract the EOB data from the EOB data stream and store it on the EOB System database. This database can exist on a database server system that rents out disk space, or can be located on a disk belonging to the EOB system, but will participate in an appropriate and sound backup strategy. Whatever the specific nature of the database server system, however, the principles of confidentiality and restricted access to patient information will be maintained.

When the medical care provider connects to the EOB System web site via their standard Internet Browser program, the EOB system will send them an “EOB Log On” web page to enable the user to log on to the EOB System. When the medical care provider types in the log on information and selects the log on button, the “EOB Log On” web page will send an http message that contains the user's log on information. Such “log on” pages are well known in the art and can be of varying format.

When the EOB System Web Server receives this http message, it will validate the user's log on, and if it is valid will send the “EOB Search” Web page to the user's browser. From this web page the user can enter his EOB search criteria. Such criteria will include, but may not be limited to:

1. Get all EOB data that belongs to medical care provider.

2. Get all EOB data that belongs to the medical care provider for a specified time frame.

3. Get EOB data that belongs to the medical care provider for a specific patient.

When the user enters the search criteria and selects the “Get EOB” button, the EOB Search page will direct the Browser to send the search criteria to the web server as an HTTP Request. When the EOB System Web Server receives this request it will search the database for the EOB data defined by the search criteria. After the Web Server retrieves this information from the database it will send the “EOB Information” web page to the user's browser. The browser will interpret the web page and will display it in the browser. This web page will display a page's worth of info, and display the Next Page button, so the user can view more information as desired. The user will be able to print the data, using the Browser's Print function. Of course, this is only a single possible embodiment of the present invention, but is illustrative of the methods by which the present invention will function.

The specific programming that will achieve the functions described above is not critical to the present invention, as it is the centralization of EOB files from multiple insurance carriers for access by medical care providers that is the important feature of the present invention. Many of the web browser interactive functions are well known in the prior art, and the transfer of information electronically is also known, but it is the specific combination of features of the present invention which is neither taught nor suggested in the prior art of EOB file management.

It is to be understood that numerous modifications, additions and substitutions may be made to the explanation of benefits system of the present invention which fall within the intended broad scope of the above description. For example, the specific communications link between the insurance company, EOB web server and medical care provider may be of any acceptable electronic data transfer system, although it is expected that use of the Internet will be most efficient. Also, the specific nature and design of the database is not critical to the present invention so long as the cross referencing and functional abilities of the database are not degraded or destroyed. Finally, the present invention is designed to greatly increase the efficiency by which EOBs are paid out and therefore minor modifications to the EOB system of the present invention which improve performance or improve efficiency are also contemplated.

There has therefore been shown and described an explanation of benefits file distribution system which accomplishes at least all of its intended objectives.

I claim:

1. An explanation of benefits/remittance advice file (EOB file) sharing and distribution system comprising:
at least two EOB file generating sources;
a central EOB file storage database in electronic information transmission connection with said at least two EOB file generating sources, said central EOB file storage database operative to receive EOB files from said at least two EOB file generating sources, organize said EOB files within said central EOB file storage database and store said EOB files in said central EOB file storage database such that said EOB files are accessible via a remote data transfer means;
at least one medical care provider in access-controlled electronic information transmission connection with said central EOB file storage database via said remote data transfer means such that said at least one medical care provider can access EOB files stored in said central EOB file storage database; and
said at least two EOB file generating sources, said central EOB file storage database and said at least one medical care provider cooperating to transfer information via said EOB files such that information regarding patients is accessible by said at least one medical care provider free of requiring separate reports submitted from said at least two EOB file generating sources to said at least one medical care provider.

2. The EOB file sharing and distribution system of claim 1 wherein said at least two EOB file generating sources comprise insurance company benefit providers.

3. The EOB file sharing and distribution system of claim 1 wherein said central EOB file storage database is stored on a computer.

4. The EOB file sharing and distribution system of claim 3 wherein said central EOB file storage database further comprises proprietary software operative to map pertinent information from each of said EOB files stored within said central EOB file storage database so that said at least one medical care provider can log onto said central EOB file storage database and access all of the EOB files connected to said at least one medical care provider.

5. The EOB file sharing and distribution system of claim 1 wherein said remote data transfer means is selected from the group consisting of a LAN, a WAN, the Internet and the World Wide Web.

6. The EOB file sharing and distribution system of claim 1 wherein said EOB files further comprise patient insurance information and remittance advice records.

7. A method of sharing and distributing explanation of benefits/remittance advice files (EOB file) comprising the steps:
providing at least two EOB file generating sources, a central EOB file storage database and at least one medical care provider;
connecting said at least two EOB file generating sources and said central EOB file storage database in electronic information transmission connection;
connecting said central EOB file storage database and said at least one medical care provider in electronic information transmission connection;
transmitting EOB files from said at least two EOB file generating sources to said central EOB file storage database;
organizing and sorting said EOB files within said central EOB file storage database whereby selected ones of said EOB files are accessible and retrievable through a database search means;
controlling access to EOB files within said central EOB file storage database whereby said at least one medical care provider can access selected EOB files stored in said central EOB file storage database; and
transferring EOB files from said central EOB file storage database to said at least one medical care provider such that insurance information regarding patients is accessible by said at least one medical care provider free of requiring separate reports submitted from said at least two EOB file generating sources to said at least one medical care provider.

8. A medical patient insurance information file sharing and distribution system comprising:
at least two medical patient insurance providers;
a central EOB file storage database in electronic information transmission connection with said at least two medical patient insurance providers, said central medical patient insurance information file storage database operative to receive medical patient insurance information files from said at least two medical patient insurance providers, organize said medical patient insurance information files within said central EOB file storage database and store said medical patient insurance information files in said central medical patient insurance information file storage database such that said medical patient insurance information files are accessible via a remote data transfer means;
at least one medical care provider in access-controlled electronic information transmission connection with said central medical patient insurance information file storage database via said remote data transfer means such that said at least one medical care provider can access medical patient insurance information files stored in said central medical patient insurance information file storage database; and
said at least two medical patient insurance providers, said central medical patient insurance information file storage database and said at least one medical care provider cooperating to transfer information via said medical patient insurance information files such that insurance information regarding patients is accessible by said at least one medical care provider free of requiring separate reports submitted from said at least two medical patient insurance providers to said at least one medical care provider.
